(19) United States
(12) Patent Application Publication
(10) Pub. No.: US 2016/0221690 A1
(43) Pub. Date: Aug. 4, 2016

(54) APPARATUS AND METHOD FOR FACILITATING BLADDER INSTALLATION AND REMOVAL

(71) Applicant: Stemit Enterprises, LLC, Jacksonville, FL (US)

(72) Inventor: Steven L. Smith, Jacksonville, FL (US)

(73) Assignee: Stemit Enterprises, LLC, Jacksonville, FL (US)

(21) Appl. No.: 14/611,357

(22) Filed: Feb. 2, 2015

(51) Int. Cl. B64F 5/00; B64D 37/06

(52) U.S. Cl. CPC B64F 5/009; B64D 37/06

(57) ABSTRACT

An apparatus for facilitating fluid bladder removal and installation from a support structure through an access opening includes a frame defining a central opening dimensioned to conform to the access opening, the frame having opposed first and second surfaces and adapted to removably mount either inside or outside the support structure around the access opening, and a plurality of roller assemblies mounted to the first surface around the central opening. The apparatus is connected inside (for removal) or outside (for installation) the support structure with the rollers extending away from and surrounding the access opening to facilitate passage of the fluid bladder.

### FIELD OF THE INVENTION

The present invention relates to the removal and re-installation or replacement of flexible fluid storage bladders from within support structures, and more particularly, to the removal and re-installation or replacement of airplane fuel bladders.

### BACKGROUND OF THE INVENTION

Flexible storage bladders are used in various applications to provide a fluid tight storage volume within another structure designed to support the bladder. One example is the use of fuel bladders on airplanes, where one or more fluid bladders are located within the wings and/or fuselage of the airplane.

To ensure fluid-tightness and integrity, fluid bladders are typically removed from within their corresponding support structures for periodic inspections. If the fluid bladder is still intact and in acceptable condition, it is then re-installed; if not, the fluid bladder must be repaired or replaced.

For removal, the fluid bladder is typically emptied and any connection points (such as fluid plumbing fittings or the like) between the fluid bladder and the surrounding structure are disconnected. The fluid bladder is then withdrawn through an access opening in the structure.

During such removals, there is a significant risk of damaging the fluid bladder through interaction between the bladder and sharp surfaces at or around the access opening. The costs associated with the otherwise unnecessary repair or replacement of fuel bladders due to damage during removal can quickly become considerable.

### SUMMARY OF THE INVENTION

In view of the foregoing, it is an object of the present invention to provide an apparatus and method for facilitating fluid bladder removal. According to an embodiment of the present invention, an apparatus for facilitating fluid bladder removal from a support structure through an access opening includes a frame defining a central opening dimensioned to conform to the access opening, the frame having opposed first and second surfaces and adapted to removably mount inside the support structure around the access opening, and a plurality of roller assemblies mounted to the first surface around the central opening. According to a method aspect, the apparatus is connected inside the support structure with the rollers extending away from and surrounding the access opening to facilitate passage of the fluid bladder. According to a further method aspect, the apparatus is connected outside the access opening to facilitate passage of the fluid bladder during installation.

These and other objects, aspects and advantages of the present invention will be appreciated in view of the drawings and following description of a preferred embodiment.

### BRIEF DESCRIPTION OF THE DRAWINGS

FIG. 1 is a bottom view of an apparatus for facilitating fuel bladder removal, according to an embodiment of the present invention;

FIG. 2 is a top view of the apparatus of FIG. 1;

FIG. 3 is a side view of the apparatus of FIG. 1;

FIG. 4 is a perspective view of the apparatus of FIG. 1, installed inside an access opening of a support structure; and

FIG. 5 is a perspective view of the apparatus of FIG. 1 in use during removal of a fuel bladder from the support structure of FIG. 4.

### DETAILED DESCRIPTION OF A PREFERRED EMBODIMENT

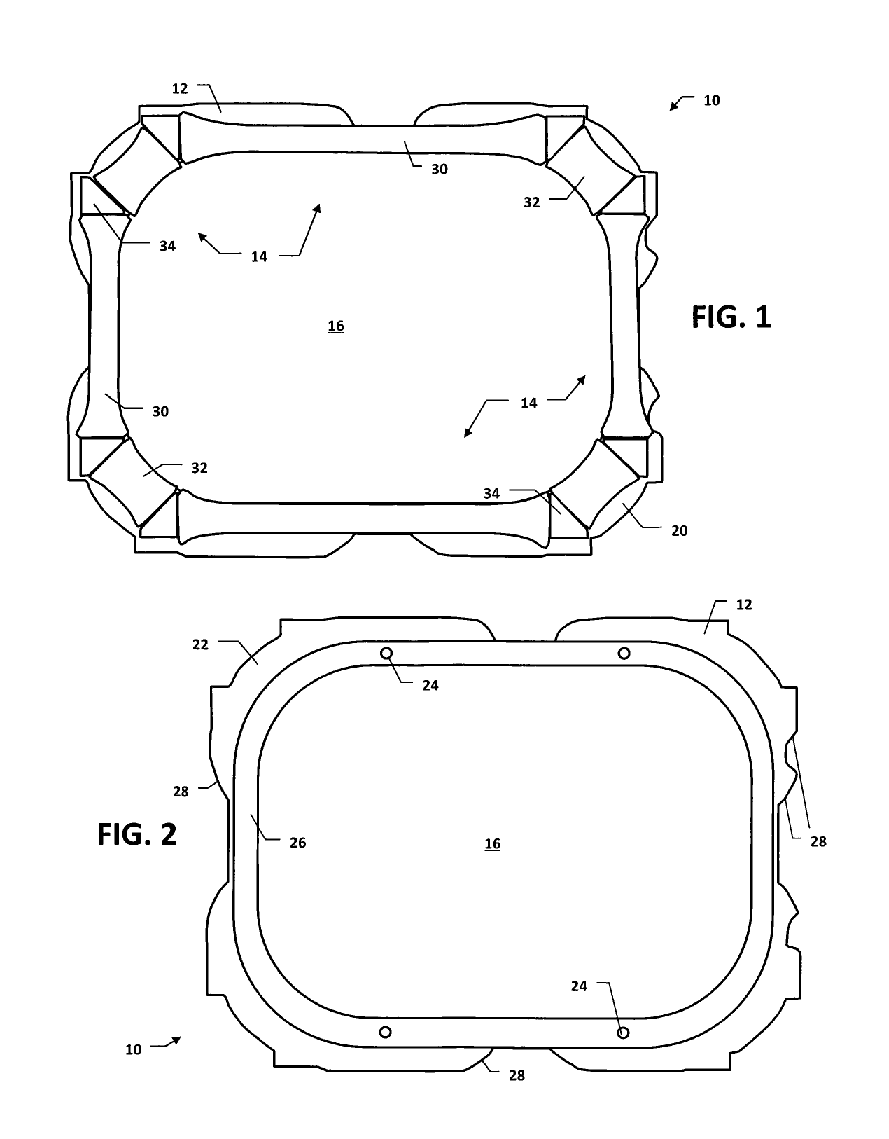

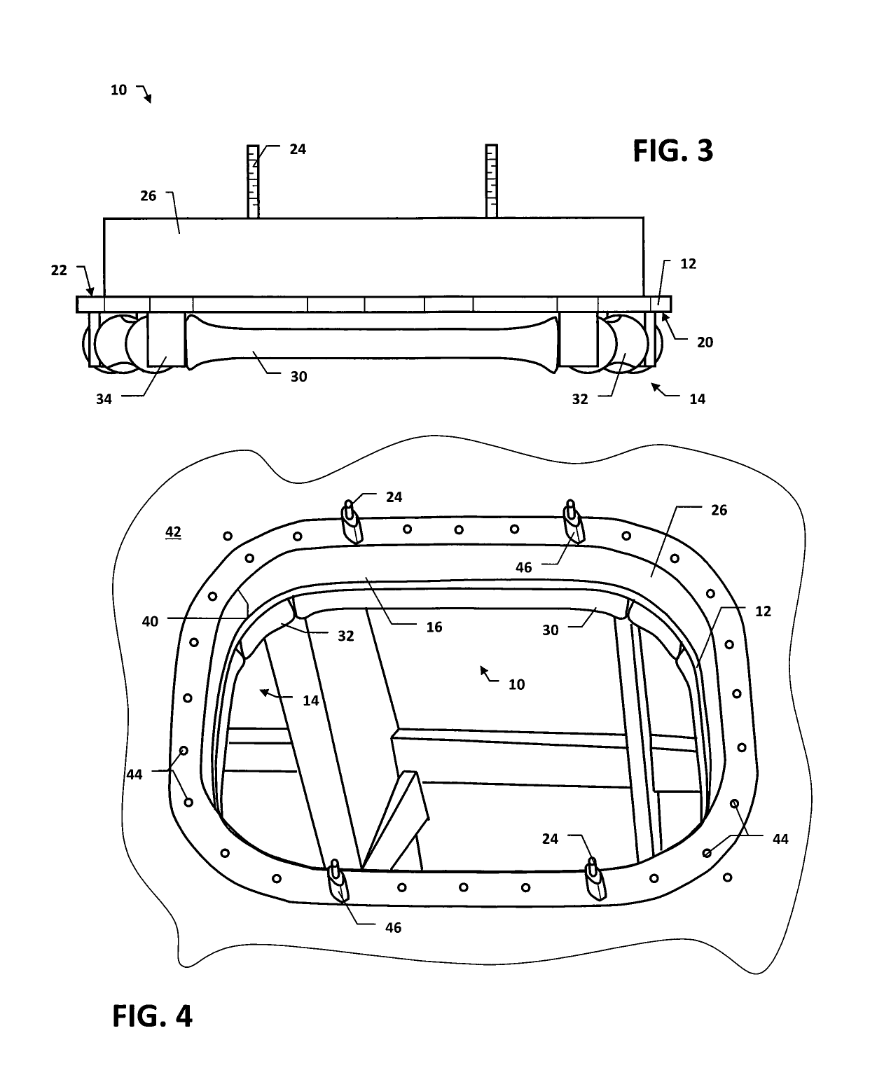

Referring to FIGS. 1-3, an apparatus 10 for facilitating fluid bladder removal includes a frame 12 with a plurality of roller assemblies 14 mounted thereto. The frame 12 defines a central opening 16 that is dimensioned to closely conform to the shape of an access opening of a support structure from which a fuel bladder will be removed. The plurality of roller assemblies 14 substantially surround the central opening 16 and are rotatable to facilitate the passage of the fuel bladder therethrough.

The frame 12 includes a first surface 20 and a generally opposed second surface 22. The roller assemblies 14 are mounted to the first surface 20 and bolts 24 or other connectors extend away from the second surface 22 to facilitate connection within the access opening. Many structures holding fluid bladders will have various structural elements arranged along inside surfaces thereof, such as stringers, struts and the like. A spacer 26 extends away from the second surface 22 to eliminate interference between the roller assemblies 14 and any such structural elements. Likewise, to ensure the frame 12 does not interfere with such structural elements, accommodation notches 28 can be formed along a periphery of the frame 12.

The number and design of notches 28, as well as the overall dimensions of the frame 12 and spacer 26 can vary depending on the support structure and fuel bladder for which the apparatus 10 is designed. Exemplary thicknesses for the frame and spacer include ¼ inch and 2 inches, respectively. Aluminum construction is advantageous for lightness and durability. In the depicted embodiment, the frame 12 and spacer 26 are separate structures, held together by the bolts 24 which extend from the second surface 22 of the frame 12 and through the spacer 26. Countersunk nuts (not shown) can be used to hold the spacer 26 to the frame 12 while still permitting the spacer to fit flush against the support structure around the insider of the access opening. Alternately, an integral frame and spacer could be used.

The roller assemblies 14 include two pairs of generally opposed side rollers 30 and two pairs of corner rollers 32 arranged between ends of the side rollers 30. The rollers in each opposed pair 30 are mounted along generally parallel axes of rotation, with the rotational axis of each side roller 30 being generally perpendicular to the adjacent side roller 30. The axes of rotation of the corner rollers 32 are offset approximately 45 degrees from each axes of rotation of its adjacent side rollers 30. The roller assemblies 14 each include mounting mechanisms 34 for rotational connection to the frame 12, with the mounting mechanisms 34 connected to the first surface 20.

The present invention is not necessarily limited to the depicted frame 12 shape, or roller assembly 14 mounting locations. It will be appreciated that the dimensions of the frame 12 and opening 16 can be adapted depending on the access opening in connection with which the apparatus 10 is intended for use. Similarly, the number and configurations of the roller assemblies 14 can also be modified. Advantageously, the rollers 30, 32 are shaped so that their inner peripheries collectively conform very closely to the shape of the central opening 16, and likewise to the opening in the rigid structure, and are aligned therewith.

Referring to FIG. 4, the apparatus 10 is connected inside the access opening 40 of a support structure 42, such as an airplane wing or fuselage. A plurality of bores 44 extends around the opening 40, which bores 44 are utilized to connect the opening 40 with the bladder and/or an access cover during normal use. The bolts 24 on the second surface 22 of the frame 12 are inserted through some of these bores 44, with which they are aligned, and secured with nuts 46. The apparatus 10 is thereby securely held around the inner side of the access opening 40, with the central opening 16 of the frame aligned therewith.

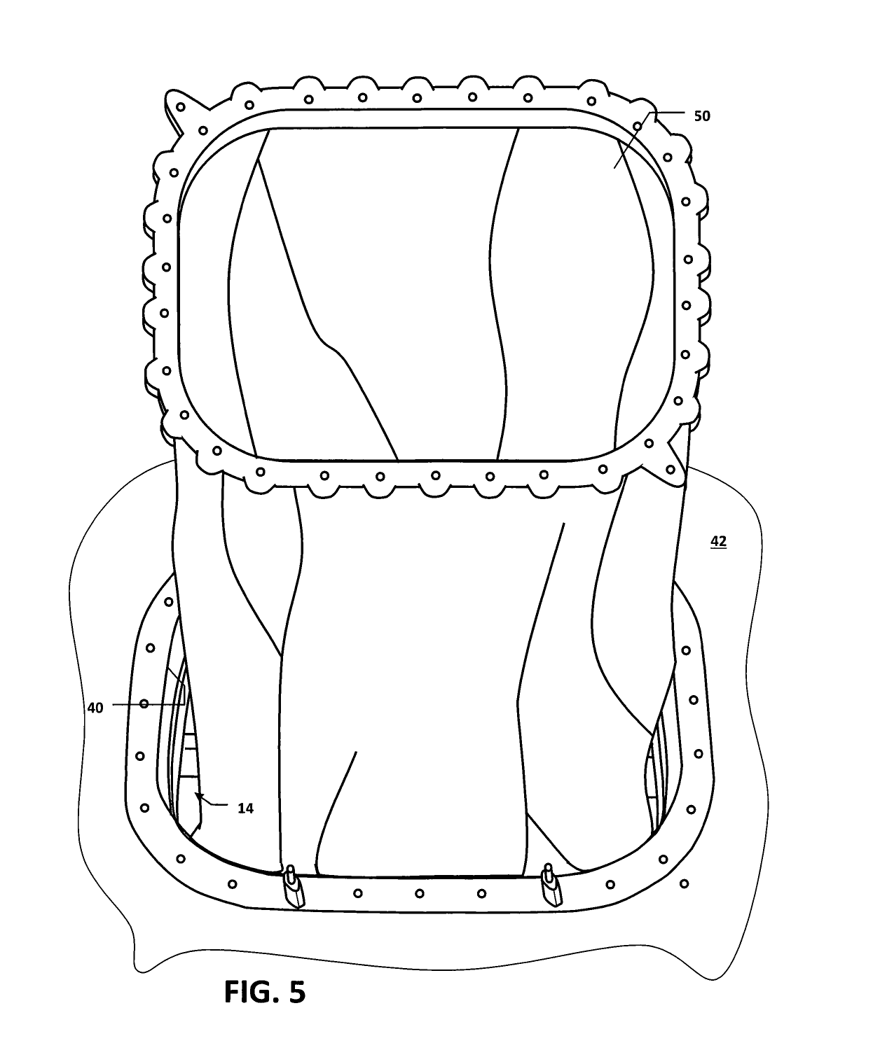

Referring to FIG. 5, the roller assemblies 14 effectively smooth the transition of a fluid bladder 50, such as a fuel bladder, when passing out of (or back into) the structure 42 through the opening 40. It has been determined that use of the apparatus 10 greatly facilitates the removal of the bladder 50 through the access opening 40, both speeding up the process of removal and minimizing the risk of damage to the bladder.

In addition to facilitating bladder 50 removal, the apparatus 10 can be employed to facilitate bladder 50 installation. If already connected, the apparatus 10 is disconnected from inside the access opening 40 and removed therefrom. The apparatus 10 is then connected outside the access opening 40 with the second surface 22 and spacer 26 facing the outer surface of the support structure 42 and the bolts 24 extending through the bores 44 into the interior space. The apparatus 10 can again be secured with nuts 46, attached to the bolts 24 inside the access opening 40. The bladder 50 in then inserted through the access opening 40, with its passage eased by the roller assemblies 14. When no longer required, the apparatus 10 is removed and stored for later use.

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described and of the claims appended hereto.

What is claimed is:

1. A method of facilitating fluid bladder installation into a support structure through an access opening, the method comprising:
connecting an apparatus outside the access opening, the apparatus having a frame and a plurality of roller assemblies extending around a central opening thereof, the apparatus being connected with the plurality of roller assemblies extending away from the access opening;
installing the fluid bladder through the plurality of roller assemblies, the central opening and the access opening.

2. The method of claim 1, wherein connecting the apparatus outside the access opening includes connecting the apparatus with a spacer extending between the frame and the access opening.

3. The method of claim 1, wherein connecting the apparatus outside the access opening includes inserting a plurality of bolts from the apparatus through openings in the support structure around the access opening.

4. The method of claim 3, wherein connecting the apparatus outside the access opening further includes attaching a plurality of nuts to the plurality of bolts inside the access opening.

5. The method of claim 1, wherein connecting the apparatus outside the access opening includes connecting the apparatus with at least two opposed pairs of side rollers surrounding the access opening.

6. The method of claim 5, wherein connecting the apparatus outside the access opening includes connecting the apparatus with at least two pairs of corner rollers, each corner roller being located between adjacent side rollers.

7. The method of claim 5, wherein connecting the apparatus outside the access includes connecting the apparatus with a shape of inner peripheries of rollers of the roller assemblies conforming to the central opening and the access opening.

8. The method of claim 1, wherein the support structure is part of an aircraft and the fluid bladder is a fuel bladder for the aircraft.
